(19) United States
(12) Patent Application Publication
(10) Pub. No.: US 2026/0019428 A1
(43) Pub. Date: Jan. 15, 2026

(54) INFORMATION COLLECTION APPARATUS, INFORMATION COLLECTION METHOD AND PROGRAM

(71) Applicant: NIPPON TELEGRAPH AND TELEPHONE CORPORATION, Tokyo (JP)

(72) Inventors: Iifan TYOU, Tokyo (JP); Takafumi HARADA, Tokyo (JP); Nami ASHIZAWA, Tokyo (JP); Ryohei SUZUKI, Tokyo (JP)

(73) Assignee: NIPPON TELEGRAPH AND TELEPHONE CORPORATION, Tokyo (JP)

(21) Appl. No.: 18/992,454

(22) PCT Filed: Jul. 15, 2022
(86) PCT No.: PCT/JP2022/027845

§ 371 Date: Jan. 8, 2025

(51) Int. Cl. H04L 9/40

(52) U.S. Cl. CPC H04L 63/126

(57) ABSTRACT

An information collection apparatus includes: a first acquisition unit configured to specify trusted nodes trusted by a certain node based on a condition, set for each of a plurality of nodes constituting a network, that the node trusts another node, and acquire conditions of each of the trusted nodes; and a second acquisition unit configured to acquire information regarding a certain target from a node specified based on the conditions acquired by the first acquisition unit, thereby increasing a likelihood of collecting highly reliable information.

### TECHNICAL FIELD

The present invention relates to an information collection apparatus, an information collection method, and a program.

### BACKGROUND ART

When individuals buy or sell information or goods over the Internet, they may refer to reviews to evaluate whether the other party is trustworthy. Similarly, in decision making or the like, determination may be made with reference to information such as reviews written by others.

Countermeasures against fake information become a problem when it comes to information such as reviews and articles written by third parties. When information is managed on a centralized platform with a centralized administrator, it is the administrator's responsibility to prevent fraudulent transactions and account fraud, and to reduce the amount of fake information. However, it is difficult for the provider to take countermeasures against tampering, and at the same time, the responsibility for implementing such countermeasures is heavy, and when combined with system maintenance, service costs become high.

As a means to solve these problems, there are decentralized platform technologies such as blockchain and DAG that can provide the security of stored data at a low cost without requiring service providers to take responsibility.

### CITATION LIST

### Non-Patent Literature

Non-Patent Literature 1: Sepandar D. Kamvar, Mario T. Schlosser, Hector GarciaMolina. “The EigenTrust Algorithm for Reputation Management in P2P Networks”. [online], Internet <URL: https://dl.acm.org/doi/pdf/10.1145/775152.775242>

Non-Patent Literature 2: Jakob Schaerer, Severin Zumbrunn, Torsten Braun. “Veritaa: A distributed public key infrastructure with signature store”. [online], Internet <URL: https://onlinelibrary.wiley.com/doi/epdf/10.1002/nem.2183>

### SUMMARY OF INVENTION

### Technical Problem

However, with the related art, it is difficult to deal with Sybil attacks on information such as reviews. As a result, it is difficult to collect highly reliable information, and there is a likelihood that fake information will be used as a reference.

The present invention has been made in view of the above points, and an object of the present invention is to increase a likelihood of collecting highly reliable information.

### Solution to Problem

In order to solve the above problem, an information collection apparatus includes: a first acquisition unit configured to specify trusted nodes trusted by a certain node on the basis of a condition, set for each of a plurality of nodes constituting a network, that the node trusts another node, and acquire conditions of each of the trusted nodes; and a second acquisition unit configured to acquire information regarding a certain target from a node specified on the basis of the conditions acquired by the first acquisition unit.

### Advantageous Effects of Invention

The likelihood of collecting highly reliable information can be increased.

### BRIEF DESCRIPTION OF DRAWINGS

FIG. 1 is a diagram showing an example of a hardware configuration of a terminal 10 used by a node in an embodiment of the present invention.

FIG. 2 is a diagram showing an example of a functional configuration of the terminal 10 in the embodiment of the present invention.

FIG. 3 is a flowchart for describing an example of a processing procedure executed by the terminal 10 when collecting reviews for a certain target.

FIG. 4 is a diagram for describing a trust range.

FIG. 5 is a diagram showing an example of provisional f.

FIG. 6 is a diagram showing an example of node information.

### DESCRIPTION OF EMBODIMENTS

In the present embodiment, a node is a person who evaluates reliability or a person whose reliability is evaluated. Each node has a terminal connected via a network.

In the present embodiment, a framework is proposed in which each of a plurality of nodes can select reviews of nodes that it can trust from among (non-tamperable) reviews shared on a decentralized platform.

In this framework, by sharing methods for narrowing down the range of trusted nodes and reputation evaluation methods with each person using a distributed ledger, it becomes possible to semi-automatically select methods and parameters by referring to the shared information, and a user's understanding is ensured by allowing shared information to be changed by individual node.

More specifically, in the present embodiment, in a set of nodes that have been evaluated as trustworthy by a “node trust evaluation method”, not only reviews themselves but also a set of a “node trust evaluation method” and a “node information aggregation method” =a trust evaluation function f used by each node are shared. Based on this, the following (a) to (c) are realized.

(a) A user can define his/her own f by referring to f (a set of a “node trust evaluation method” and a “node information aggregation method”) of each node that the user trusts. If a majority of people (direct trust +indirect trust) in a range trusted by the user share the correct f, f that is frequently used is considered a safe evaluation method in consideration of attack countermeasures of each person.

To this end, each node publishes its own “trust relationship” and “trust evaluation function f” as a set in a non-tamperable form. This makes it possible to share f, check the trust relationship with the provider of f (closeness in the trust chain or number of paths), and check the number of uses of f.

Note that publishing incorrect information may lead to loss of trust in the own node. In that case, there are disadvantages such as indirect trusters excluding the node from the trusted range, and thus the system can suppress false information.

(b) When an attack such as a fake review occurs, people with knowledge can deal with the attack by correcting their own f, and even people without knowledge can deal with the attack by using corrected f of nearby users, which increases the reliability of reviews.

Each node does not acquire f of other nodes and directly use it, but since f includes verifiable conditions, by verifying and correcting the conditions, it is possible to define and use f that is “understood” and takes into account the attack reviews around the node.

To this end, f is a function whose processing conditions (a range of reliable indirect trust, a method of majority voting statistics considering the closeness of trust relationships, and the like) are checked, and its variables, conditions, and operations can be reviewed and changed by the user as necessary.

(c) Even if there are few trusted nodes, sufficient reliability and amount of information can be ensured by aggregating “node trust evaluation methods” and “node information aggregation methods” from random seed nodes and evaluating them against other nodes.

In other words, each person publishes his or her f and continues to propagate it (publication→use→update→publication, etc.), so that even if a new attack is made, the attack can be dealt with appropriately as collective knowledge. By filtering and evaluating reviews using the widely used f, it is possible to evaluate the reliability that has succeeded the best practices of the person in the range that is trusted by the user.

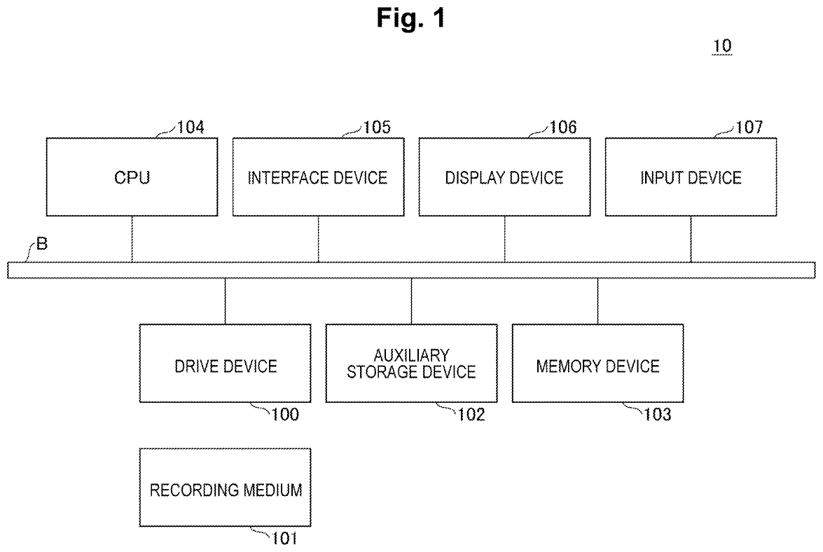

An embodiment of the present invention will be described below with reference to the drawings. FIG. 1 is a diagram showing an example of a hardware configuration of a terminal 10 used by a node in an embodiment of the present invention. The terminal 10 in FIG. 1 includes a drive device 100, an auxiliary storage device 102, a memory device 103, a CPU 104, an interface device 105, a display device 106, an input device 107, and the like, which are connected to each other via a bus B.

A program for implementing processing in the terminal 10 is provided by a recording medium 101 such as a CD-ROM. When the recording medium 101 storing the program is set in the drive device 100, the program is installed on the auxiliary storage device 102 from the recording medium 101 via the drive device 100. Here, the program is not necessarily installed from the recording medium 101 and may be downloaded from another computer via a network. The auxiliary storage device 102 stores the installed program and also stores required files, data, and the like.

When an instruction to start the program is made, the memory device 103 reads the program from the auxiliary storage device 102 and stores the program. The CPU 104 implements a function related to the terminal 10 in accordance with a program stored in the memory device 103. The interface device 105 is used as an interface for connecting to a network. The display device 106 displays a graphical user interface (GUI) or the like by the program. The input device 107 is constituted by a keyboard and a mouse, for example, and is used to input various operation instructions.

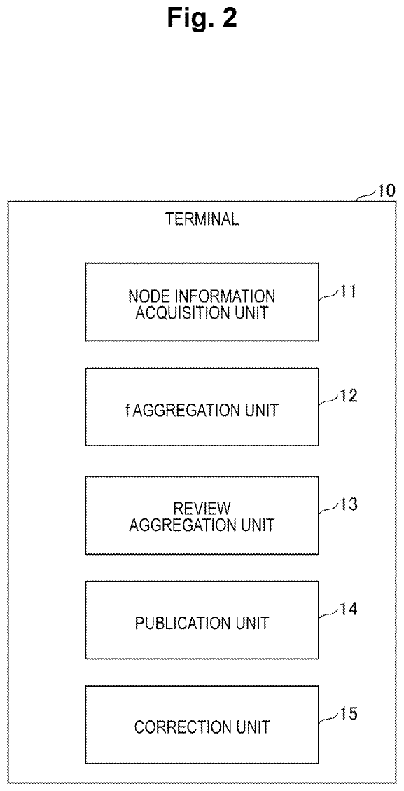

FIG. 2 is a diagram showing an example of a functional configuration of the terminal 10 in the embodiment of the present invention. In FIG. 2, the terminal 10 includes a node information acquisition unit 11, an f aggregation unit 12, a review aggregation unit 13, a publication unit 14, and a correction unit 15. These units are implemented by processing executed by the CPU 104 by one or more programs installed in the terminal 10.

Note that, in the present embodiment, (the terminal 10 of) each node publishes f (“a node trust evaluation method” and a “node information aggregation method”) used for evaluation of reliability in a distributed ledger or the like in a non-tamperable form.

The “node trust evaluation method” is a method for specifying trusted nodes, and includes a parameter indicating a condition (hereinafter referred to as a “trust condition”) for being a trusted node (defining a trust range) and a filter for the trust condition.

Examples of the trust condition include one or more of the following (1) to (5).
(1) Indirect trust target degree
(2) Number of usage records
(3) Presence or absence of third-party certification for ID
(4) Random reference
(5) Designated direct trust target

The indirect trust target degree in (1) is a condition for specifying the trust range by the number of hops that recursively trace the trust relationship.

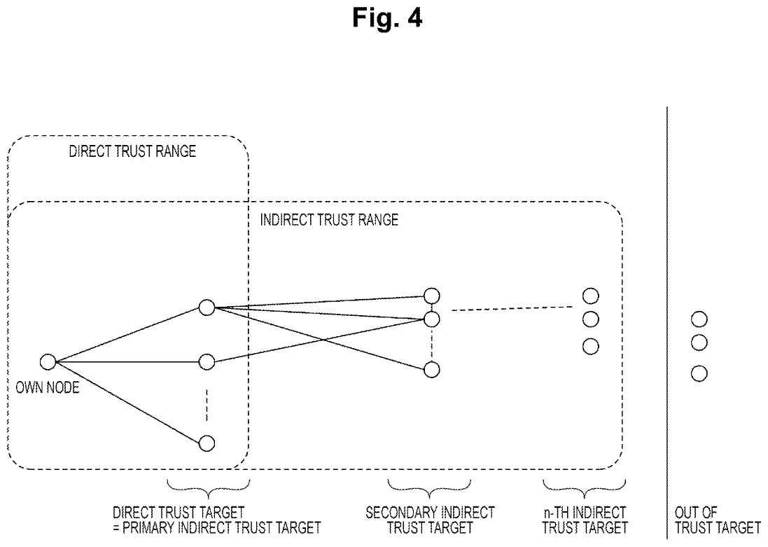

FIG. 4 is a diagram for describing a trust range. In FIG. 4, the trust relationship is expressed in a graph form. In the graph shown in FIG. 4, white circles indicate nodes. The leftmost node is a node serving as a starting point of the trust range (hereinafter referred to as a “starting node”). Lines connecting nodes indicate trust relationships. Each of a direct trust range and an indirect trust range is indicated by a broken line. As illustrated, the indirect trust range also includes the direct trust range.

A group of nodes included in the indirect trust range whose number of hops from the starting node is n is referred to as an n-th indirect trust target. Since the number of hops of a group of nodes included in the direct trust range is 1, the group of nodes corresponds to the primary indirect trust target. The indirect trust target degree is the value of this n.

The number of usage records in (2) is a condition for specifying trusted nodes based on the number of usage records of f published by each of the nodes.

The presence or absence of third-party certification for the ID in (3) is a condition for making a node whose ID (node ID) has been certified (for example, signed) by a third party a trusted node.

The random reference in (4) is a condition for making m nodes randomly selected from the indirect trust range trusted nodes. Therefore, in the case of random reference, the value of m is designated as a parameter.

The designated direct trust target in (5) is a condition for making a designated node among the direct trust targets (primary indirect trust target) a trusted node.

Note that two or more values may be designated from among (1) to (5). In this case, the logical product of the conditions indicated by the selected value becomes a valid condition.

On the other hand, a filter is a parameter for excluding some nodes from a group of nodes (trust range) that match trust conditions. For example, according to the filter, it is possible to exclude f associated with a node with an absolutely low evaluation from a group of nodes that match the trust conditions based on the EigenTrust value.

Examples of filters include the following (1) to (3).
(1) SybilLimit
(2) EigenTrust
(3) Total trust

SybilLimit in (1) is a filtering method that focuses on the lack of social connections between Honest users and attackers (https://ieeexplore.ieee.org/document/4531141).

EigenTrust in (2) is a filtering method that focuses on trust evaluation based on trust value propagation and convergence (http://ilpubs.stanford.edu:8090/562/1/2002-56.pdf).

Total trust in (3) means not to exclude. That is, in this case, nodes are not excluded from the trusted group of nodes that match the trust conditions.

The “node information aggregation method” is a method of aggregating node information published by each trusted node specified by the “node trust evaluation method” into one piece of node information. In the present embodiment, the “node information aggregation method” includes an extraction method, a processing method, a minimum number of reviews, and the like.

The extraction method is a method of extracting one piece of node information that aggregates the node information of each trusted node. As the extraction method, for example, the following values can be designated.
(1) Average extraction
(2) Most frequent extraction

Average extraction in (1) is to extract the average of node information. The most frequent extraction in (2) is to extract node information with the highest frequency of appearance (most frequent node information).

The processing method indicates a method of calculating parameters of node information extracted by the extraction method. For example, for (2) most frequent extraction, examples of processing methods include rounding off the average value of the parameters of the node information with the highest frequency of appearance (most frequent node information), and weighting according to the indirect trust degree.

The minimum number of reviews is a threshold value for determining whether or not f in the node information aggregated by the extraction method and the processing method is to be adopted as a candidate for f of the own node. Specifically, when the number of reviews acquired from each trusted node is equal to or greater than the minimum number of reviews, f in the aggregated node information is determined as a candidate for adoption of f of the own node.

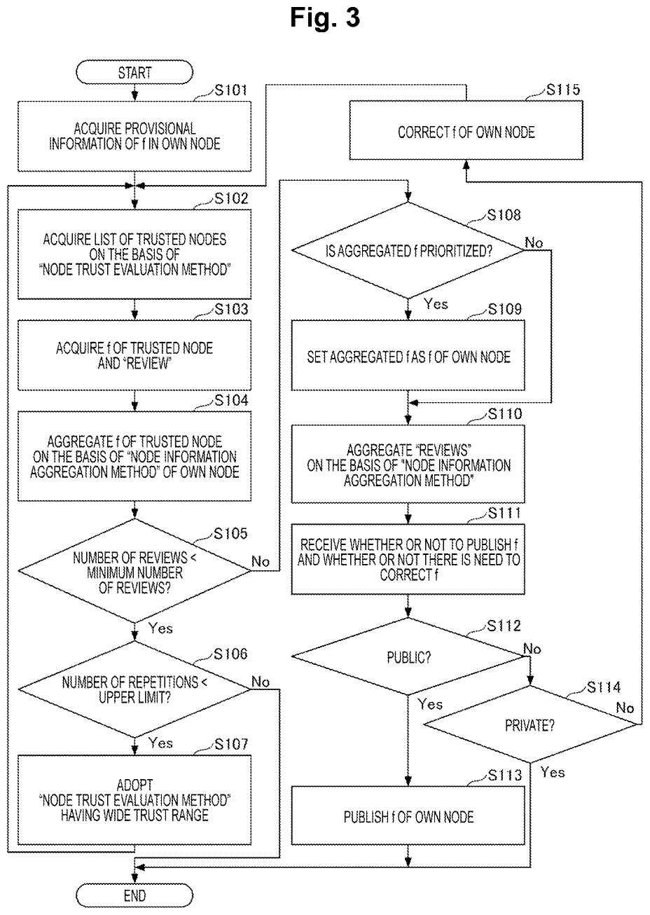

A processing procedure executed by the terminal 10 will be described below. FIG. 3 is a flowchart for describing an example of a processing procedure executed by the terminal 10 when collecting reviews for a certain target. The review collection target (hereinafter referred to as a “target of interest”) is input by the user. For example, the target of interest is designated by the name of a specific target, such as a restaurant name.

In step S101, the node information acquisition unit 11 acquires provisional information (hereinafter referred to as “provisional f”) of f (a set of a “node trust evaluation method” and a “node information aggregation method”) of the own node. The provisional f may be stored in advance in the auxiliary storage device 102 or the like, or may be automatically generated by the node information acquisition unit 11.

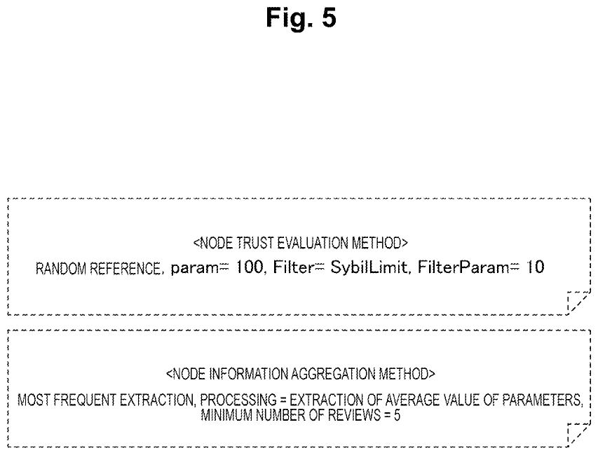

FIG. 5 is a diagram showing an example of provisional f. FIG. 5 shows a “node trust evaluation method” and a “node information aggregation method” that constitute provisional f.

In the “node trust evaluation method” in FIG. 5, “random reference, param =100” is a setting related to a trust condition, and “Filter=SybilLimit, FilterParam=10” is a setting related to a filter. That is, in this example, the trust condition is to randomly select 100 nodes as trusted nodes from the indirect trust range. Furthermore, the SybilLimit method is set as a filter, and 10 is set as a parameter for this method.

The “node information aggregation method” in FIG. 5 indicates that f with the highest frequency of appearance is extracted and the average value is adopted as the parameter of the extracted f, and that the minimum number of reviews is 5.

Following step S101, the node information acquisition unit 11 acquires a list of trusted nodes on the basis of the “node trust evaluation method” of f of the own node (S102). At the time when step S102 is executed for the first time, f of the own node is provisional f. In this case, 100 nodes are randomly selected from the indirect trust range.

Note that the indirect trust range can be specified on the basis of the “trust relationship” included in node information published by each node (set for each node).

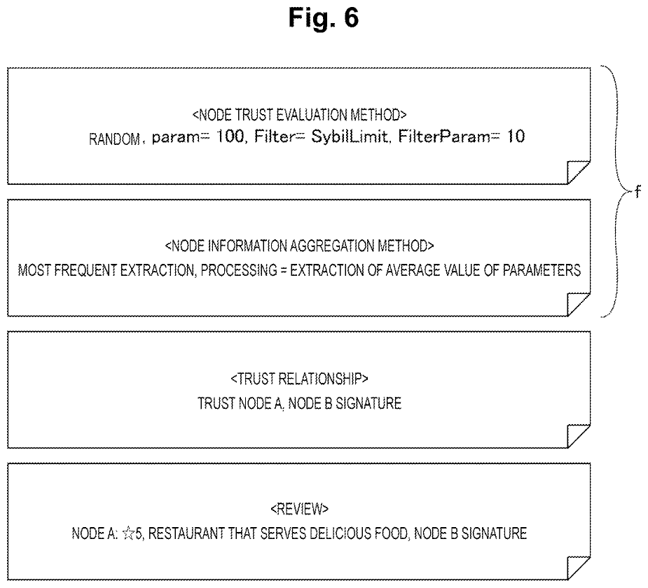

FIG. 6 is a diagram showing an example of node information. As shown in FIG. 6, the node information includes “node trust evaluation method” and “node information aggregation method” that constitute f, “trust relationship”, and “review”. Among these, the “trust relationship” is information indicating a node trusted by a node related to the node information. The example in FIG. 6 shows that node B trusts node A. That is, FIG. 6 shows an example of node information of node B. Note that each node may be reviewing a plurality of targets. Therefore, each piece of node information can include a plurality of “reviews”.

Such node information is published for each node in a non-tamperable state. For example, each piece of node information is recorded in a distributed ledger.

Subsequently, the node information acquisition unit 11 acquires f (“node trust evaluation methods” and “node information aggregation methods”) and “reviews” of node information of the trusted nodes included in the list of the trusted nodes (S103). Note that with regard to “reviews”, only “reviews” related to the target of interest need be acquired.

Subsequently, the f aggregation unit 12 aggregates f (the “node trust evaluation methods” and the “node information aggregation methods”) of the trusted nodes on the basis of the “node information aggregation method” of the own node (S104). When step S104 is executed for the first time, the “node information aggregation method” of the own node is the “node information aggregation method” of provisional f (FIG. 5). Therefore, in this case, the f aggregation unit 12 performs aggregation by extracting the most frequent f from among the f (the “node trust evaluation methods” and the “node information aggregation methods”) of the trusted nodes, and setting the average value of parameters of the extracted f as a parameter of aggregated f. Furthermore, as is clear from the fact that the average value of the parameters is calculated, in determining the commonality of f when specifying the most frequent f, the difference between the values of the parameters of the trust condition, filter, extraction method, and processing method is not considered. Since the minimum number of reviews is a numerical value itself, the difference between them is not considered in determining the commonality. However, the method of determining the commonality of f may be changed as appropriate.

Subsequently, the f aggregation unit 12 determines whether or not the number of “reviews” acquired in step S103 is less than the minimum number of reviews constituting part of the “node information aggregation method” of the own node (S105).

If the number of “reviews” is less than the minimum number of reviews (Yes in S105), that is, if the number of reviews is insufficient compared to the expected number, the f aggregation unit 12 determines whether or not the number of repetitions after step S102 is less than the upper limit (S106). If the number of repetitions after step S102 exceeds the upper limit (No in S106), the processing procedure in FIG. 3 ends.

If the number of repetitions after step S102 is less than the upper limit (Yes in S106), the f aggregation unit 12 selects a “node trust evaluation method”, which has the widest trust range (has the loosest trust conditions) than the “node trust evaluation method”, from each “node trust evaluation method” to be aggregated according to the “node information aggregation method” of the own node as a “node trust evaluation method” of the own node (S107), and repeats step S102 and subsequent steps. For example, when the trust condition of each “node trust evaluation method” to be aggregated is random reference, a “node trust evaluation method” with the largest number of randomly selected items is selected. When the trust condition of each “node trust evaluation method” to be aggregated is the indirect trust target degree, a “node trust evaluation method” with the largest indirect trust target degree n is selected. By adopting a “node trust evaluation method” that has a relatively wide trust range, it can be expected that reviews will be collected from more nodes.

On the other hand, if the number of “reviews” acquired in step S103 is equal to or greater than the minimum number of reviews constituting part of the “node information aggregation method” of the own node (No in S105), the review aggregation unit 13 determines whether or not to prioritize the aggregated f over f of the own node (S108). Whether or not to prioritize the aggregated f over f of the own node may be set in advance, or may be input by the user in step S108. If prioritizing f of the own node (No in S108), the process proceeds to step S110 without executing step S109. If prioritizing the aggregated f (Yes in S108), the review aggregation unit 13 sets the aggregated f as f of the own node (replaces f of the own node with the aggregated f) (S109), and proceeds to step S110.

In step S110, the review aggregation unit 13 aggregates the “reviews” acquired in step S103 on the basis of the “node information aggregation method” of the own node. Here, the “node information aggregation method” of the own node is the “node information aggregation method” of the aggregated f when step S109 is executed. The “reviews” are aggregated, for example, by calculating the mode value or average value of the number of stars on the basis of the “node information aggregation method”. Further, the comments of “reviews” may be aggregated, for example, by generating a list of each “review” to be aggregated.

Subsequently, the publication unit 14 receives from the user whether or not there is a need to correct f of the own node and whether or not to publish f of the own node when it is not corrected (S111). At this time, the publication unit 14 may display the contents of f of the own node, the aggregated “reviews”, and the like on the display device 106 as determination materials.

For example, when the trust range is too wide, it may become the target of an attack. Therefore, the user determines whether or not there is a need to correct f by, for example, checking whether or not the trust range indicated by the “node trust evaluation method” of f of the own node is too wide (whether or not it exceeds the allowable range), whether or not the trust range deviates from the evaluation criteria of the reliability of the own node, and the like. When the user determines that there is no need to correct f, the user inputs whether or not to publish it.

If there is no need to correct f of the own node and it is possible to publish it (Yes in S112), the publication unit 14 executes a process to publish f of the own node (S113). The process to publish f of the own node refers to bringing into a state that can be referred to by another node. At this time, it is desirable that f be published in a state where there is a high likelihood that it will not be tampered with. For example, f may be made public by recording f in a distributed ledger. By doing so, it is possible to ensure the tampering resistance of the distributed ledger. Furthermore, the use of the “node trust evaluation method” and the “node information aggregation method” based on zero-knowledge proofs on the distributed ledger can be concealed from third parties. In addition, by executing the smart contract, it is possible to manage the number of times of reference and the number of times of practical use of the public information of the user and to improve the priority of f having a large number of times of practical use. Note that when the published f is used, an economic reward may be given to the user who published the f, thereby providing an incentive for publishing the f.

Alternatively, if there is no need to correct f of the own node and f is to be made private (No in S112 and Yes in S114), step S113 is not executed and the processing procedure of FIG. 3 ends.

Alternatively, if there is a need to correct f of the own node (No in S112 and No in S114), the correction unit 15 corrects f according to a correction instruction from the user (S115). For example, correction is made to narrow the trust range. Alternatively, when the user determines that the trust range is too narrow, correction may be made to widen the trust range. It is up to the user to decide what kind of correction is to be made.

Subsequently, step S102 and the subsequent steps are repeated on the basis of the corrected f. As a result, “reviews” based on the corrected f are obtained.

As described above, according to the present embodiment, it is possible to increase the likelihood of collecting highly reliable reviews (information).

Furthermore, since the “node trust evaluation method” and “node information aggregation method” are defined by the user, they can be set and changed according to their own use case. Furthermore, the parameters can be adjusted by the user himself/herself. Since the system does not impose the optimal rule definition, it is possible to increase the user's understanding and the degree of freedom.

Additionally, since f is propagated between nodes, when each of users (nodes) detects an attack, the users can correct their own rules and propagate indirect countermeasures against the attack to the trust range.

Furthermore, when the reviews (information) are insufficient, the trust range can be further expanded, thereby increasing the likelihood of obtaining sufficient reviews (information).

Note that in the present embodiment, a review for a certain target has been described as an example of information regarding the target, but the present embodiment may be applied to information other than reviews regarding the target. For example, the present embodiment may be applied to articles and various types of information regarding a certain target.

Note that in the present embodiment, the terminal 10 is an example of an information collection apparatus. The node information acquisition unit 11 is an example of a first acquisition unit and a second acquisition unit. The f aggregation unit 12 is an example of an aggregation unit.

Although the embodiment of the present invention has been described in detail above, the present invention is not limited to such a specific embodiment, and various modifications and changes can be made within the scope of the gist of the present invention described in the claims.

### Reference Signs List

10 Terminal

11 Node information acquisition unit

12 f aggregation unit

13 Review aggregation unit

14 Publication unit

15 Correction unit

100 Drive device

101 Recording medium

102 Auxiliary storage device

103 Memory device

104 CPU

105 Interface device

106 Display device

107 Input device

B Bus

1. An information collection apparatus comprising:
a processor; and
a memory storing program instructions that cause the processor to:
specify trusted nodes trusted by a certain node based on a condition, set for each of a plurality of nodes constituting a network, that the node trusts another node, and acquire conditions of each of the trusted nodes; and
acquire information regarding a certain target from a node specified based on the acquired conditions.

2. The information collection apparatus according to claim 1,
wherein the program instructions cause the processor to aggregate the acquired conditions, and
acquire the information from a node specified based on the aggregated conditions.

3. The information collection apparatus according to claim 2,
wherein the program instructions cause the processor to acquire an aggregation method of the conditions set for each of the trusted nodes, and
aggregate the acquired conditions based on the acquired aggregation method.

4. The information collection apparatus according to claim 2
wherein the program instructions cause the processor to correct the aggregated conditions according to an instruction from a user, and
specify trusted nodes based on the corrected conditions.

5. An information collection method executed by a computer, the information collection method comprising:
specifying trusted nodes trusted by a certain node based on a condition, set for each of a plurality of nodes constituting a network, that the node trusts another node, and acquiring conditions of each of the trusted nodes; and
acquiring information regarding a certain target from a node specified based on the acquired conditions.

6. A non-transitory computer-readable recording medium storing a program for causing a computer to perform the information collection method of claim 5.
